(19) United States
(12) Patent Application Publication
(10) Pub. No.: US 2001/0003755 A1
(43) Pub. Date: Jun. 14, 2001

(54) High-temperature-gelation-resistant material, method for making same, and coatings and articles including same

(76) Inventors: Denise Elizabeth Fiori, Trumbull, CT (US); Richard James Quinn, Bethel, CT (US)

Correspondence Address: PENNIE & EDMONDS LLP, 1667 K STREET NW, SUITE 1000, WASHINGTON, DC, 20006

(21) Appl. No.: 09/736,126

(22) Filed: Dec. 15, 2000

Related U.S. Application Data
(63) Continuation-in-part of application No. 09/032,518, filed on Feb. 27, 1998.
(63) Continuation-in-part of application No. 09/032,519, filed on Feb. 27, 1998.
(63) Continuation-in-part of application No. 09/609,837, filed on Jul. 5, 2000.

(51) Int. Cl. B01F 3/08; B01F 17/00

(52) U.S. Cl. 516/67

(57) ABSTRACT

The present invention relates generally to improved high-temperature-gelation-resistant acrylic materials, particularly for use with a polyisocyanate crosslinker in forming low volatile organic compound (VOC) content, curable, oil-in-water emulsions for aqueous coatings. Incorporation of methacrylic acid into copolymers containing COOH and OH groups facilitates the manufacture of low viscosity, low molecular weight, low-VOC acrylic copolymers. Polyols made from methacrylic acid can be maintained at higher temperatures and/or for longer periods of time while maintaining their low viscosities and molecular weights as compared to polyols synthesized from acrylic acid. Low viscosities and molecular weights after polymerization with methacrylic acid comonomers can be maintained at higher temperatures and for longer periods of time than polymers including acrylic acid comonomers, as previously used in the prior art.

### CROSS-REFERENCE TO RELATED APPLICATION(S)

This application is a continuation-in-part of co-pending U.S. patent application Ser. Nos. 09/032,518 and 09/032,519, both filed on Feb. 27, 1998, and co-pending U.S. patent application Ser. No. 09/609,837, filed on Jul. 5, 2000, the entire disclosures of each of which are incorporated herein by express reference thereto.

### FIELD OF THE INVENTION

The present invention generally relates to improved surface-active, isocyanate-reactive, acrylic materials, for use with a polyisocyanate crosslinker in forming low volatile organic compound (VOC) content, curable, oil-in-water emulsions, as well as aqueous coatings and articles including same.

### BACKGROUND OF THE INVENTION

Isocyanate crosslinked systems are in general well known. As an example, polyurethane films can be formed from coating compositions based upon polyols and polyisocyanate crosslinking agents. Polyurethane coatings can be formulated to provide fast curing characteristics, as well as a desirable combination of abrasion resistance, flexibility, adhesion, chemical resistance and appearance characteristics in the resulting films.

Due to the reactivity of isocyanates with active hydrogen containing compounds, including water, polyurethane coatings have historically been formulated as two-component organic-solvent-based systems. One-component systems, both organic-solvent-based and waterborne (see, e.g., British Patent Nos. GB 1530021 and GB 1530022), have also been formulated by blocking of the isocyanate groups via well-known blocking agents.

Despite the excellent films that can be achieved with some of these systems, and particularly the two-component organic-solvent-based systems, the coatings industry is under great pressure to reduce the environmentally undesirable emission of VOC'S, which includes the organic solvent media as well as the common isocyanate blocking agents. One means of doing so, of course, would be to exchange some or all of the liquid organic solvent medium with water. Unfortunately, the switch from organic solvents to water is neither a simple nor straightforward matter, particularly in the case of common isocyanate crosslinkers, which are not only reactive with water, but are also hydrophobic and non-dispersible.

Several approaches to lowering the VOC of polyurethane coatings are reprinted in N. T. Cullen, “Low-VOC Polyurethane Coatings: Current Successes and Promising Developments,” American Paint & Coatings Journal, Aug. 19, 1991, pp. 44-49 and 64. One such approach has been to preform a water-dispersible film-forming polyurethane polymer by reacting a polyisocyanate with a hydrophilic reactive component, then dispersing the so-preformed hydrophilic polymer in water. A variation on this approach, disclosed in British Patent No. GB 1162409, is to preform the polyurethane polymer in situ in the aqueous medium with the aid of non-reactive surfactants. A still further variation on this approach is described in European Patent No. EP-A-0369389, in which a lower molecular weight water-dispersible prepolymer containing residual isocyanate functionality is first formed by reaction of a mixture of isocyanates with a polyol chain containing hydrophilic groups, after which the prepolymer is dispersed in water and chain extended or crosslinked. Upon application of these preformed polymer systems to a substrate, films are formed primarily via physical drying mechanisms due to evaporation of the liquid medium (water). While such preformed polyurethane systems can significantly reduce emitted VOCs, they often suffer from application and stability problems. In addition, films produced from such systems can suffer from poor water resistance due to the hydrophilic nature of the preformed polymers or surfactants remaining after cure.

In another approach disclosed in British Patent No. GB-A2018796 and U.S. Pat. No. 4,663,377, an emulsifiable polyisocyanate mixture comprising (a) a hydrophilic isocyanate-functional oligomer and (b) a polyisocyanate, is produced by partially reacting a polyisocyanate with, for example, a hydrophilic polyether alcohol. Curable coating and adhesive compositions can be formed by combining these polyisocyanate emulsions with separate aqueous resins. The emulsifiable polyisocyanate mixtures of these references, however, suffer from low isocyanate content, which results from the destruction of some of the isocyanate groups when the polyisocyanate is allowed to partially react with the polyether, as well as the destruction of some of the isocyanate groups due to the reaction with water upon and after emulsification. Predictably, a low isocyanate content would severely reduce the ability of these polyisocyanate mixtures to function as efficient crosslinkers in coating compositions. In addition, these polyisocyanate emulsions suffer from stability problems due to the reaction of isocyanate groups with water, particularly those on the hydrophilic component (a).

In a similar approach disclosed in U.S. Pat. No. 5,202,377, an emulsifiable polyisocyanate mixture comprising (a) a hydrophilic tertiary isocyanate-functional oligomer and (b) a polyisocyanate having tertiary isocyanate groups, is produced by partially reacting a polyisocyanate containing tertiary isocyanate groups with a hydrophilic polyether. Coating compositions can be formed by combining (i) these polyisocyanate emulsions with (ii) separate aqueous solutions, emulsions or dispersions of film-forming polymers containing isocyanate-reactive functionality. These emulsifiable mixtures are reported to produce more stable emulsions than those of U.S. Pat. No. 4,663,377 due to the lower reactivity of tertiary isocyanate groups. Despite the lower reactivity of the tertiary isocyanate groups, coatings produced from these emulsions may still suffer from low isocyanate content as well as stability problems.

Still another approach to reducing the VOC of isocyanate crosslinked systems is found in U.S. Pat. No. 5,075,370. This reference generically discloses an aqueous coating composition comprising an aqueous solution and/or dispersion of a surface-active isocyanate-reactive resin (anionic olefinic polyol) into which a specific, relatively low viscosity, liquid, unblocked polyisocyanate crosslinker is emulsified. The disclosed aqueous coating compositions are produced by emulsifying the isocyanate crosslinker into the aqueous solution and/or dispersion of the isocyanate-reactive resin to produce an oil-in-water emulsion. It has, however, been found that, when systems were prepared in accordance with the teachings of U.S. Pat. No. 5,075,370 (emulsification of the isocyanate into the aqueous resin solution/dispersion), the isocyanates do not properly incorporate into the resin solution/dispersion—nor is an acceptable emulsion produced. After a short period of time a two phase system results, and films obtained from such systems display poor appearance characteristics, i.e., are hazy, contain microblisters, and have little or no gloss.

A solution to some of the problems associated with the systems disclosed in U.S. Pat. No. 5,075,370 has been described in U.S. Pat. No. 5,466,745. This patent teaches a curable aqueous oil-in water emulsion prepared by admixing an aqueous medium with a non-aqueous, emulsifiable composition comprising an unblocked polyisocyanate crosslinking agent and a surface-active isocyanate-reactive material. While excellent stability and ultimate film properties can be achieved with the systems of this patent, viscosity and mixing constraints of the emulsifiable composition may require the addition of diluents prior to admixture with the aqueous medium, thereby undesirably increasing the VOC of the final formulated composition.

U.S. patent application Ser. No. 09/032,518 discloses a process for preparing an isocyanate-based, curable oil-in-water emulsion having a low-VOC content comprising (i) admixing (a) a substantially hydrophobic, unblocked isocyanate crosslinking agent with (b) a mixture of (b1) a water dispersible, surface-active isocyanate-reactive material and (b2) an aqueous medium wherein the mixture (b) is used so as to produce a substantially homogenous curable water-in-oil emulsion of low-VOC content; and then (ii) admixing the curable water-in-oil emulsion from (i) with an aqueous medium in proportions and under conditions so as to produce a substantially homogenous curable oil-in-water emulsion of low-VOC content.

U.S. patent application Ser. No. 09/032,519 discloses an improved process for the preparation of such an emulsion comprising (i) admixing (a) a substantially hydrophobic, unblocked isocyanate crosslinking agent with (b) a mixture of (b I) a partially-neutralized, water-dispersible, surface-active, isocyanate-reactive material, having a hydroxyl content of at least about 1.8 wt % and a T_{g} of at least about 15° C., and (b2) an aqueous medium wherein the mixture is used so as to produce a substantially homogenous curable water-in-oil emulsion of low-VOC content; and then (ii) admixing the curable water-in-oil emulsion from (i) with an aqueous medium in proportions and under conditions so as to produce a substantially homogenous curable oil-in-water emulsion of low-VOC content. This patent application teaches that the particle size distribution of the oil-in-water curable emulsion can influence the drying time of the coating, and that a lower percent neutralization of the carboxylic acid group in the surface-active, isocyanate-reactive material can lead to the production of smaller particle size oil-in-water emulsions for hydrophilic polyols. Further, this application discloses that the addition of a hydrophobic monomer, or the addition of a long chain hydroxyl monomer can lead to coatings that exhibit faster drying times.

### SUMMARY OF THE INVENTION

One aspect of the present invention relates to an improved polymeric, macromonomeric, or oligomeric high-temperature-gelation-resistant material including sterically hindered acid groups, preferably carboxylic acid groups, and acid-reactive groups, e.g., hydroxyl and/or amino groups, preferably hydroxyl groups. Advanatageously, the copolymer is formed by free-radical polymerization of methacrylic acid monomers with at least one hydroxy-functional comonomer and, optionally, at least one other acrylate or methacrylate comonomer. The improvement in the gelation-resistant material is that it exhibits an improved pot-life, i.e., a viscosity below about 1000 cps, preferably below about 500 cps, more preferably below about 300 cps, or an Mₙ of about 1,000 to 50,000, for at least about 60 minutes, preferably at least about 120 minutes, more preferably at least about 180 minutes, preferably at a temperature in the range of about 115° C. to 180° C. or at about the polymerization temperature, alternately within about 50° C., preferably within about 20° C., of the polymerization temperature. In a preferred embodiment, the sole source of the carboxylic acid groups is from incorporated methacrylic acid monomers.

Another aspect of the present invention relates to a process for improving the pot life of a surface-active, isocyanate-reactive material that includes copolymerizing methacrylic acid monomers with at least one hydroxy-functional comonomer and, optionally, at least one other acrylate or methacrylate comonomer, at a sufficient polymerization temperature and for a sufficient time to create a copolymer with a viscosity below about 1000 cps or an Mₙ between about 1,000 and 50,000, wherein the viscosity of the material remains below about 1000 cps or the Mₙ remains between about 1,000 and 50,000 at the polymerization temperature or at a temperature in the range of about 115° C. to 180° C. for at least about 60 minutes, preferably at least about 120 minutes, more preferably at least about 180 minutes.

It has also surprisingly been discovered that low-VOC, isocyanate-based aqueous curable compositions can be readily achieved when the primary components of the systems described in U.S. Pat. No. 5,466,745—the aqueous medium, isocyanate crosslinking agent (containing at least two reactive isocyanate groups, and which in and of itself is substantially hydrophobic and non-dispersible in water) and surface-active, isocyanate-reactive material or a high-temperature-gelation-resistant material according to the invention—are formulated according to a different process which, in accordance with one aspect of the present invention, includes the steps of: (i) admixing (a) an unblocked isocyanate crosslinking agent containing at least two reactive isocyanate groups, the agent being substantially hydrophobic and non-dispersible in water, with (b) a mixture of a surface-active, isocyanate-reactive material or a high-temperature-gelation-resistant material according to the invention, and an aqueous medium, wherein, in the mixture, the material is water-dispersible; in proportions and under conditions sufficient to produce a substantially homogenous curable water-in-oil emulsion having a VOC content of about 2.1 lbs/gal (252 g/l) or less; and then (ii) admixing the curable water-in-oil emulsion from step (i) with an aqueous medium in proportions and under conditions sufficient to produce a substantially homogenous oil-in-water emulsion of the material and the isocyanate crosslinking agent in water.

The present invention also relates to the precursor curable water-in-oil emulsion resulting from step (i). Specifically, this curable water-in-oil emulsion includes a substantially homogenous emulsion of water in a substantially homogenous mixture of a surface-active, isocyanate-reactive material or a high-temperature-gelation-resistant material according to the invention that is water-dispersible, and (a) an unblocked isocyanate crosslinking agent containing at least two reactive isocyanate groups, the agent being substantially hydrophobic and non-dispersible in water, the curable water-in-oil emulsion having a VOC content of about 2.1 lbs/gal (252 g/l) or less, more preferably about 2 lbs/gal (240 g/l) or less, and especially about 1.9 lbs/gal (228 g/l) or less.

The present invention further relates to the substantially homogenous, curable oil-in-water emulsion prepared by the above process, and an aqueous curable composition based on this substantially homogenous, curable oil-in-water emulsion, possessing a VOC content of about 2.1 lbs/gal (252 g/l) or less, more preferably about 2 lbs/gal (240 g/l) or less, and especially about 1.9 lbs/gal (228 g/l) or less.

VOC content, for the purposes of the present invention, is measured in accordance with United States Environmental Protection Agency Method 24.

Optionally, such curable water-in-oil emulsions and the curable oil-in-water emulsions derived therefrom may also include one or more of a neutralizing agent for rendering the surface-active isocyanate material water-dispersible, a relatively minor amount (at most) of an organic solvent, a cure catalyst, and other well known auxiliaries and additives suited for the particular end use, to the extent that such optional components do not raise the VOC content above the aforementioned level.

As with the curable oil-in-water emulsions of U.S. Pat. No. 5,466,745, and U.S. patent application Ser. Nos. 09/032,518 and 09/032,519, the curable oil-in-water emulsions of the present invention, prepared by the process of the present invention, are substantially homogeneous; on standing for an appropriate length of time (generally, for less than a day or a few hours), they do not separate into multiple phases, and they do have a relatively long pot life before gelation (at least about 60 minutes, preferably at least about 120 minutes, more preferably at least about 180 minutes, and in some cases at least about 240 minutes, at elevated temperatures); when cured, films obtained from curable oil-in-water emulsions prepared in accordance with the present invention have excellent physical and appearance characteristics; and, furthermore, by proper selection of the emulsion components as described herein, films can be obtained that possess outstanding clarity and gloss, and that are substantially free, preferably completely free, of microblisters.

The present invention farther relates to low molecular weight, low solvent content, water-dispersible, surface-active, isocyanate-reactive materials, on their own or included in these emulsions.

One advantage of the present invention over the prior art, as discussed above, is that systems can be readily and easily formulated and still have very low-VOC contents. The present invention demonstrates improved film performance compared to fims produced by the prior art. Further, this improvement in performance can be obtained over a wide range of molecular weights (Mₙs) and polydispersities. As compared to compositions disclosed in the art, the present invention demonstrates an improvement in that relatively low viscosity, as well as molecular weight and polydispsersity, can be maintained for prolonged periods at elevated temperatures.

Another aspect of the present invention relates to a coating on an article, or an article including a coating, that includes any high-temperature-gelation-resistant material according to the invention and/or made by a process according to the invention or any curable emulsion according to the invention and/or made by a process according to the invention.

Another aspect of the invention involves a process for forming any coating according to the invention on an article by drying any curable emulsion according to the invention and/or made by a process according to the invention. For example, the coating can be provided on an article by applying to an article an isocyanate-based, curable oil-in-water emulsion formed according to the process described herein, and drying the emulsion to form a coating. It should be understood that the application of the coating can be done by any method available to those of ordinary skill in the art, such as by depositing, brushing, dipping, or the like.

### BRIEF DESCRIPTION OF THE DRAWINGS

Further features and advantages of the invention can be ascertained from the following detailed description that is provided in connection with the drawing(s) described below:

FIG. 1 shows the propensity for the surface-active, isocyanate-reactive materials of Comparative Examples 8 through 15 to exhibit undesirable increases in viscosity after polymerization over a certain short period of time.

FIG. 2 shows the propensity for the surface-active, isocyanate-reactive materials of Comparative Examples 8, 12, 13, 16, and 17 to exhibit undesirable increases in viscosity after polymerization over a certain period of time.

FIG. 3 shows a comparison of the viscosity behavior over time (after polymerization) of the surface-active, isocyanate-reactive material of Comparative Example 8 with that of the high-temperature-gelation-resistant material according to the invention (Example 20).

FIG. 4 shows a comparison of the viscosity behavior over time (after polymerization) of the surface-active, isocyanate-reactive materials of Comparative Examples 8 and 18 with that of the high-temperature-gelation-resistant materials according to the invention (Examples 19-21).

FIG. 5 shows a comparison of the viscosity behavior over time (after polymerization) of the surface-active, isocyanate-reactive materials of Comparative Examples 16 and 17 with that of the high-temperature-gelation-resistant material of Example 22.

### DETAILED DESCRIPTION OF THE PREFERRED EMBODIMENTS

One aspect of the invention relates to polymeric, macromonomeric, or oligomeric materials that contain at least two different types of functional groups that, under the proper conditions, can react together to form an ester or amide linkage. Despite the presence of these two types of functional groups, however, the materials made according to the invention are surprisingly resistant to gelation at elevated temperatures for extended times. The at least two different types of functional groups can include: (1) at least one acid group, such as a carboxylic acid, sulfonic acid, or phosphonic acid; and (2) at least one carboxylic acid-reactive group, for example, such as a hydroxyl group, amino group, or a mixture thereof, such that the ester or amide linkage that can be formed may be a traditional (carbon-based) ester or amide, a sulfonate ester or sulfonamide, or a phosphonate ester or phosphonamide. Preferred carboxylic acid-reactive groups are hydroxyl groups, while preferred acid groups are carboxylic acid groups. Preferably, when the material is formed from a reaction of one or more monomers, the sole source of the carboxylic acid groups in these materials is from sterically hindered carboxylic acid-containing monomers incorporated into the reaction. These sterically hindered monomers have the following polymerized repeat structure:

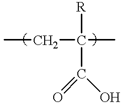

wherein R is not a hydrogen, preferably wherein R contains at least 1-12 carbons, more preferably at least 1∝4 carbons. In a preferred embodiment, R is a hydrocarbon alkyl radical. In a more preferred embodiment, R is a methyl group. Also preferably, when the material is formed from a reaction of one or more monomers, one source of hydroxyl groups in these materials is from hydroxylalkyl acrylates or methacrylates having about 2 to 12 carbons in the alkyl moiety. Examples include hydroxybutyl acrylate or hydroxyethyl acrylate, preferably hydroxybutyl acrylate.

The preferred high-temperature-gelation-resistant material is polymeric in nature, with the at least two types of functional groups being incorporated into the polymer via appropriate monomer selection and/or by any subsequent modification known or available to those of ordinary skill in the art. Examples include, but are not limited to: olefinic copolymers based on carboxyfunctional ethylenically unsaturated monomers and hydroxyfunctional ethylenically unsaturated monomers; polyesters based on polybasic carboxylic acids and polyhydric alcohols; polyurethanes based on polyisocyanates, polyhydric alcohols and hydroxy acids; polyepoxy esters; and the like. Especially preferred for use in the present invention are the olefinic copolymers, and especially acrylics, i.e., those which contain at least one acrylate or alkacrylate, e.g., such as methacrylate, monomer.

Surprisingly, these acrylic copolymers containing methacrylic acid offer better resistance to undesirable viscosity increases, compared to those containing acrylic acid, at elevated temperatures, e.g., within about 50° C., preferably within about 20° C., or alternately at about the temperature of polymerization. In some cases, the polymerization or reaction temperature can be between about 115° C. and 180° C., preferably from about 140° C. to 160° C., more preferably at or around about 150° C. In any event, undesirable viscosity increases are those that bring the viscosity of the high-temperature-gelation-resistant material above about 1000 cps, preferably above about 500 cps, more preferably above about 300 cps. The methacrylic acid-containing acrylic copolymers according to the invention exhibit resistance to undesirable viscosity increases, i.e., such that the viscosity falls outside of the acceptable range mentioned herein, for at least about 60 minutes, preferably for at least 120 minutes, more preferably for at least 180 minutes, at elevated temperatures, which may be below, at, or above the polymerization or reaction temperature.

Without being bound to theory, it is believed that the presence of a more sterically hindered carboxylic acid monomer in the high-temperature-gelation-resistant copolymers according to the invention may reduce the propensity for reactivity between pendant hydroxyl (or amino) and carboxylic acid (or other acid) groups, which can cause esterification of the polymers. Esterification can occur in these polymers and can increase the viscosity and the molecular weight to the point of gelation, which destroys equipment and is costly to clean up. Esterification reactions are further activated by heat; thus, the higher the temperature at which the copolymer material is kept, the more, or the more likely, esterification will occur. By inhibiting esterification through the incorporation of sterically hindered carboxylic acid comonomers, the high-temperature-gelation-resistant copolymers according to the invention may retain their lower viscosities (and their lower molecular weights) for longer times, e.g., after the completion of the polymerization but while the polymer is still being held at elevated temperatures. This improvement allows copolymers containing both hydroxyl and carboxylic acid groups to be able to be processed more effectively and on an industrial scale with less undesirable post-polymerization side-reactions leading to gelation.

Another aspect of the invention relates to a polyurethane coating formed from an emulsion containing high-temperature-gelation-resistant material of the present invention and an isocyanate curing or crosslinking agent. Suitable polyisocyanate crosslinking agents are generally well known in the art and have been extensively used in coating compositions in a monomeric, oligomeric and/or polymeric form. To function as an effective crosslinking agent, the polyisocyanate preferably has at least two reactive isocyanate groups.

Suitable polyisocyanate crosslinking agents for use in the present invention may include any liquid or solid organic polyisocyanate containing at least two reactive isocyanate groups. In addition, such polyisocyanate crosslinking agents should in and of themselves be substantially hydrophobic and non-dispersible in water. Suitable polyisocyanate crosslinking agents may contain aliphatically-, cycloaliphatically-, araliphatically- and/or aromatically-bound isocyanate groups. Mixtures of polyisocyanates are also suitable. Particularly preferred are those polyisocyanates containing aliphatically, cycloaliphatically and/or araliphatically bound polyisocyanates including, but not limited to, the following specific examples: hexamethylene diisocyanate; 2,2,4-trimethylhexamethylene diisocyanate; 2,4,4-trimethylhexamethylene diisocyanate; meta-α,α,α′,α′-tetramethylxylylenediisocyanate (commercially available under the trade designation TMXDI® (meta) aliphatic isocyanate from Cytec Industries Inc., West Paterson, N.J.); para-α,α,α′,α′-tetramethylxylylenediisocyanate; 1-isocyanato-3,3,5-trimethyl-5-isocyanatomethyl cyclohexane (isophorone diisocyanate, abbreviated as IPDI); bis(4-isocyanatocyclohexyl)methane (hydrogenated MDI); biuret derivatives of various diisocyanates including, for example, hexamethylene diisocyanate (commercially available under the trade designation Desmodur® N of Bayer Corp., Pittsburgh, Pa.); uretdione derivatives of various diisocyanates including, for example, hexamethylene diisocyanate and IPDI; isocyanurate derivatives of various diisocyanates including, for example, hexamethylene diisocyanate (commercially available under the trade designation Desmodur N 3390 of Bayer Corp.) and IPDI (commercially available under the trade designation IPDI T 1890 polyisocyanate of Huls America, Inc., Piscataway, N.J.); and urethane adducts of diisocyanates with polyols such as, for example, ethylene glycol, propylene glycol, neopentyl glycol, trimethylolpropane, pentaerythritol and the like, as well as oligomeric and polymeric polyols, and any mixture thereof.

The preferred polyisocyanate crosslinking agents are those having at least one non-primary isocyanate group. Also preferred are the urethane diisocyanate/polyol adducts, more preferably those having an NCO content of at least about 10 weight percent (on a 100% solids basis), and especially those wherein the diisocyanate contains at least one non-primary isocyanate group. Particularly preferred are such urethane adducts having an average NCO functionality of greater than 2, and especially the diisocyanate/trimethylolpropane adducts. An especially preferred example of such is the 3:1 meta-α,α,α′,α′-tetramethylxylylenediisocyanate/trimethylolpropane (TMXDI/TMP) adduct commercially available under the trade designation CYTHANE® 3174 aliphatic polyisocyanate resin of Cytec Industries Inc., which has the following properties:

| | |
|---|---|
| Non-Volatiles (% by weight) | 74 ± 1.0 |
| NCO Content (% by weight on Solution) | 10.2 ± 0.5 |
| Solvent | Butyl Acetate |

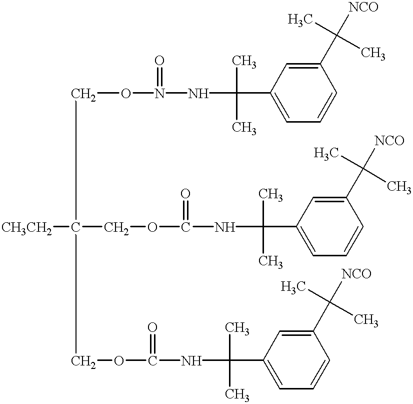

CYTHANE ® 3174

Another preferred example of a TMXDI/TMP adduct has the following properties:

| | |
|---|---|
| Non-Volatiles (% by weight) | 72 |
| NCO Content (% by weight on Solution) | 9.6 |
| Solvent (90:10) | Methyl Amyl Ketone/Acetone |

Another example of a diisocyanate/trimethylolpropane adduct is a 3:1 IPDI/trimethylolpropane adduct commercially available under the trade designation SPENLITE(® 25-A4-60 aliphatic urethane prepolymer of Reichhold Chemicals, Research Triangle Park, N.C.

The surface-active isocyanate-reactive material contains both (i) functionality capable of reacting with isocyanate groups, as well as (ii) hydrophilizing functionality capable of rendering the surface-active isocyanate-reactive material water dispersible. It is believed that, in the ultimate curable oil-in-water emulsions, the reactive material acts as a surfactant for emulsifying the isocyanate crosslinkers and other hydrophobic components. In the final film, the surface-active material is incorporated into the crosslinked network by virtue of its reactivity with the isocyanate crosslinkers, leading to improved water resistance.

The preferred surface-active isocyanate-reactive material is polymeric in nature, with the hydrophilizing groups and isocyanate-reactive functionality being incorporated into the polymer via appropriate monomer selection and/or subsequent modification is well known to those of ordinary skill in the art. Examples include, but are not limited to: olefinic copolymers based on carboxyfunctional ethylenically unsaturated monomers and hydroxyfunctional ethylenically unsaturated monomers; polyesters based on polybasic carboxylic acids and polyhydric alcohols; polyurethanes based on polyisocyanates, polyhydric alcohols and hydroxy acids; polyepoxy esters; and the like; as well as mixtures thereof. Especially preferred for use in the present invention are the olefinic copolymers.

“Isocyanate-reactive functionality,” as used herein, refers to functionality that is typically reactive with isocyanate groups under normal conditions, preferably under cure conditions of the curable emulsions. Such isocyanate-reactive functionality is generally well known to those of ordinary skill in the art and includes, most commonly, active hydrogen-containing functionality, such as hydroxyl and amino groups. Hydroxyl groups are typically utilized as the isocyanate-reactive functionality in coatings and are preferred for use in the present invention.

Hydrophilizing functionality is also generally well known to those of ordinary skill in the art and includes, most commonly, anion generating, cation generating and hydrophilic non-ionic functionality. By “anion generating” and “cation generating” is meant functionality, such as carboxyl (anion generating) or amino (cation generating), that, when appropriately neutralized, becomes hydrophilic in nature. Hydrophilic non-ionic functionality is, in and of itself, hydrophilic in nature. The amount of hydrophilizing functionality present in the isocyanate-reactive material should, upon at least partial neutralization of the anion generating or cation generating groups (if present), be sufficient to render the isocyanate-reactive material water-dispersible.

Besides the aforementioned carboxyl groups, other examples of suitable groups that generate anions upon neutralization include sulfonic and phosphoric groups. Besides the aforementioned amino groups (substituted and unsubstituted), other examples of suitable groups that generate cations upon neutralization may include substituted and unsubstituted sulphonate groups, and substituted and unsubstituted phosphate groups, as well as mixtures thereof. Examples of suitable hydrophilic non-ionic functionality include, but are not limited to, amine oxide, phosphine oxide, alkyl or aryl phosphate, and polyether (e.g., polyethylene oxide). Preferred hydrophilizing groups for most applications are those which can generate anions upon neutralization and, particularly, the carboxyl and sulfonic groups. Especially preferred are carboxyl groups.

When coating compositions are formulated from the oil-in-water emulsions of the present invention, it is especially preferred that the polyisocyanate crosslinker and the surface-active isocyanate-reactive material include the primary film-forming components of the coating. In such a case, the surface-active isocyanate-reactive material preferably possesses the following characteristics:

a number average molecular weight (Mₙ) of from about 1,000 to about 50,000, more preferably from about 1,000 to about 12,000;

an acid number of from about 15 mg to about 150 mg KOH/G resin, more preferably from about 20 mg to about 70 mg KOH/G resin, especially from about 20 mg to about 40 mg KOH/G resin on an as is basis, or about 30 mg to about 50 mg KOH/G resin per 100% solids basis;

an amount of hydroxyl groups of from about 2.5 weight percent to about 6 weight percent, preferably from about 3 weight percent to about 5 weight percent, more preferably from about 3.5% to about 4.5 weight percent (100% solids basis); and

optionally, a viscosity of not more than about 1000 cps, preferably not more than about 500 cps, more preferably less than about 300 cps.

In addition, the isocyanate-reactive material may optionally have a relatively low glass transition temperature (T_{g}) of about 25° C. or less, depending upon certain desired cure/drying characteristics. For example, for ambient cure systems the surface-active isocyanate-reactive material should have a low T_{g} of preferably below 0° C. to increase reactivity with the isocyanate crosslinking agent. Where fast physical drying characteristics are important, higher T_{g} materials may be used, e.g., those which include comonomers, such as styrene or the like, that increase the T_{g} of the resulting copolymer.

Particularly preferred surface-active isocyanate-reactive materials include copolymers of methacrylic acid or acrylic acid, hydroxyalkyl acrylates or methacrylates, such as 4-hydroxybutyl acrylate, 2-hydroxyethyl acrylate, or a combination thereof, and, optionally, other free-radically polymerizable monomers, e.g., alkyl acrylates, such as butyl acrylate or the like, alkyl methacrylates, such as methyl methacrylate or the like, or combinations thereof, which, when polymerized, meet the above characteristics. When the surface-active isocyanate-reactive materials include acrylate and/or acrylic acid monomers, it is more preferred that methacrylic acid be used, as opposed to acrylic acid, and it is also more preferred that 4-hydroxybutyl acrylate be used, as opposed to 2-hydroxyethyl acrylate.

In a preferred embodiment, the surface-active isocyanate-reactive materials of the present invention include a copolymer of a styrene and 4-HBA, in addition to other comonomers including acrylic acid (AA), butyl acrylate (BA) and methyl methacrylate (MMA). It was discovered that the incorporation of the surface-active isocyanate-reactive materials as a copolymer surprisingly and unexpectedly produced a film that demonstrated improved performance compared to a film produced by simply blending the styrenated and the 4-HBA surface-active isocyanate-reactive materials in various ratios.

Further, it was discovered that this improvement in performance can be obtained over a wide range of molecular weights (Mₙ) and polydispersities. Low Mₙ and low polydispersities are desirable for obtaining low viscosity polyols, as such low viscosity polyols facilitate mixing of the polyisocyanate crosslinking agent into the water-dispersed, surface-active, isocyanate-reactive material, and for low-VOC levels of the formulated system. The degree of robustness found in the systems including the preferred surface-active, isocyanate-reactive materials of the invention as a copolymer was unusual and unexpected.

In a preferred embodiment, the combination of monomers employed in a polymerization to create the surface-active, isocyanate-reactive material of the invention includes a longer chain hydroxyalkyl (meth)acrylate, such as 4-hydroxybutyl (meth)acrylate, and an aromatic monomer, e.g., such as styrene. In a more preferred embodiment, the combination includes a long chain hydroxyalkyl (meth)acrylate, a styrene, and a crosslinker based on a tertiary polyisocyanate. A faster and more complete cure can occur with a more flexible hydroxyl chain, while the development of a shorter drying time under ambient conditions and of more quickly developing hardness under forced dry conditions are surprising. Incorporation of about 5 wt % to 20 wt %, preferably about 8 wt % to 15 wt %, more preferably about 10 wt %, styrene into a surface-active acrylic polyol based on 2-hydroxyethyl (meth)acrylate also shortens the drying time and more quickly develops an acceptable hardness in the system. Without being bound by theory, it is believed that these improvements may be related to the smaller particle size distribution of the curable emulsion, resulting from the introduction of an aromatic monomer such as styrene. Particle size was shown to affect the drying times of coatings prepared from surface-active polyols based on acrylic acid monomers. In comparison, achieving the same properties of short drying time and early hardness by increasing the glass transition temperature of the acrylic-based polyol can lead to coatings that do not develop complete solvent resistance. In particular, it has been found that the addition of styrene provides preferred results when the polyol (i.e., the surface-active, isocyanate-reactive material) has a hydroxyl content of about 1.5 wt % (48% solids) and a T_{g} of less than about 0° C.

It should be noted that, for applications such as electrodeposition, the common hydrophilizing functionality is cation generating. Especially preferred for such uses are amino groups, and similar considerations to those set forth above (with the exception of acid number being exchanged for amine equivalency) would apply to the surface-active isocyanate-reactive materials utilized in forming curable emulsions for this application.

Although the polyisocyanate crosslinker and the surface-active isocyanate-reactive material can be present in the water-in-oil and oil-in-water emulsions in varying amounts, when these components are used as the primary film-forming components of a subsequently formed coating, it is preferred that they be present in the emulsions in amounts such that the NCO:OH reactive functionality ratio is in the range of about 0.5:1 to about 2:1, and especially in the range of about 0.8:1 to about 1.2:1.

The emulsifiable compositions may also include additional ingredients such as, for example, one or more neutralizing agents for rendering the surface-active isocyanate material water-dispersible, cure catalysts, or relatively minor amounts of an organic solvent, or combinations thereof.

When an anion generating group is present on the isocyanate-reactive material, any base may be used as the neutralizing agent to produce an anionic surface-active material. Normally, a base capable of converting a carboxyl group to a carboxylate anion is included as a neutralizing agent. Suitable bases include, but are not limited to, one or more of organic and inorganic bases, such as sodium and potassium hydroxide, sodium and potassium carbonate, and amines, such as ammonia, primary, secondary and tertiary amines. Tertiary amines and ammonia are preferred, and particularly tertiary amines, such as triethyl amine.

Similarly, when a cation generating group is present on the isocyanate-reactive material, any acid, or a combination of acids, may be used as the neutralizing agent to produce a cationic surface-active material.

As discussed in further detail below, when included, the neutralizing agents may be present at any stage of the process, for example, as a component of the aqueous medium or as a part of the surface-active isocyanate-reactive material (preneutralization). In any case, the total amount of optional neutralizing agent should be at least be sufficient to render the surface-active, isocyanate-reactive material water-dispersible. The level of neutralization can have an effect on the particle size distribution of the final oil-in-water curable emulsion. Generally speaking, the smaller the particle size in an oil-in-water emulsion, the greater the tendency that faster drying times will result. For more hydrophilic polyols, typically those with higher hydroxyl contents (at least about 1.8 wt % based on 48% solids) and higher glass transition (T_{g}) temperatures (at least about 15° C.), a reduced level of neutralization can improve the compatibilization and give the desired smaller particle size distribution. For more hydrophobic polyols, decreasing the amount of neutralization may increase the particle size of the oil-in-water emulsion. In particular, it may be desirable to decrease neutralization of the hydrophilizing functional groups to about 30% to about 60%, preferably to about 40% to about 50%. An indication of particle size can be obtained by observing the appearance of the oil-in-water emulsion. A bluish opalescence appearance frequently indicates a desired particle size distribution. As the appearance becomes more milky, a less desirable particle size distribution is generally indicated. Oil-in-water curable emulsions with a median particle size less than about 0.2 μm are preferred, and especially preferred emulsions have median particle size of about 0.11 μm to 0.16 μm.

Cure catalysts for isocyanates are well known to those of ordinary skill in the coatings art. Preferred catalysts include, but are not limited to, organometallic catalysts and, particularly, organotin compounds such as dibutyltin di-2-ethylhexoate, dibutyltin diisooctyl maleate, dibenzyltin di-2-ethylhexoate, dibutyltin dilaurate, dimethyltin dilaurate, tetrabutyl diacetoxy distannoxane, tetramethyl diacetoxy distannoxane, tetrapropyl diacetoxy distannoxane, dibutyltin dichloride, and the like, as well as mixtures thereof. A preferred catalyst for tertiary polyisocyanates is a dimethyltin dicarboxylate sold under the trade name Fomrez® UL 28, by Witco Corporation of Greenwich, Conn.

Any organic solvents present in the emulsifiable compositions are generally those present in the various components, as it is preferable to avoid adding additional organic compounds to help reduce, or keep low, the VOC of the resultant coatings. For example, many coatings components are not commercially available on a 100% solids basis, but are rather available at a somewhat lower solids content in an appropriate solvent, as required to achieve a particular viscosity suitable for mixing.

Depending on their end use, the emulsions of the present invention may also include other well known auxiliaries and additives. Those typically utilized in the coatings industry include, for example, foam inhibitors, leveling aids, pigments, pigment dispersing aids, dyes, UV absorbers (including, but not limited to, hydroxy aryl triazine types, e.g., such as CYASORB® UV-1164 from Cytec Industries Inc., benzotriazole types, e.g., such as CYASORB® UV-2337 from Cytec Industries Inc., and benzophenone types, as well as mixtures thereof), heat stabilizers, other stabilizing additives such as antioxidants, hindered amine light stabilizers (such as Sanduvor™ 3055 and 3058 from Novartis AG), and the like, as well as mixtures thereof.

These optional ingredients are in general well-known to those of ordinary skill in the art. Reference may specifically be made to U.S. Pat. Nos. 4,426,471; 4,344,876; 4,619,956; 5,106,891; 5,322,868; and 5,461,151, and European Patent Nos. EP-A-0434608, EP-A-0444323, and EP-A-0704437, all of which are incorporated herein by express reference hereto, as if fully set forth, for detailed discussions of the stabilization of coatings and other curable compositions with UV absorbers, hindered amine light stabilizers, and/or other types of light stabilizers, that are also suitable for use in accordance with the present invention.

As mentioned above, the process for preparing low-VOC, isocyanate-based aqueous curable compositions according to the present invention includes the steps of:

(i) admixing (a) an unblocked isocyanate crosslinking agent containing at least two reactive isocyanate groups, the agent being substantially hydrophobic and non-dispersible in water, with (b) a mixture of a surface-active isocyanate-reactive material and an aqueous medium, wherein, in the mixture (b), the surface-active, isocyanate-reactive material is water-dispersible; in proportions and under conditions sufficient to produce a substantially homogenous curable water-in-oil emulsion having a VOC content of about 2.1 lbs/gal (252 g/l) or less; then

(ii) admixing the curable water-in-oil emulsion from step (i) with an aqueous medium in proportions and under conditions sufficient to produce a substantially homogenous oil-in-water emulsion of the surface-active, isocyanate-reactive material and the isocyanate crosslinking agent in the aqueous medium, the oil-in-water emulsion having a VOC content of about 2.1 lbs/gal (252 g/l) or less.

Preferably, the water-in-oil and oil-in-water emulsions from steps (i) and (ii), respectively, have VOC contents of about 2 lbs/gal (240 g/l) or less, and especially about 1.9 lbs/gal (228 g/l) or less.

As stated earlier, a key aspect to obtaining improved results is to first prepare a copolymer containing the surface-active isocyanate-reactive materials, then to prepare a water-in-oil emulsion of the components, and finally to add additional aqueous medium until phase inversion occurs. Additional aqueous medium can then be added to adjust the resulting oil-in-water emulsions to the desired solids content and viscosity as appropriate for a chosen end use. The admixing can be accomplished by any number of well known techniques, but preferably by:

(i) adding the aqueous medium, either continuously or in portions, to the surface-active isocyanate-reactive material to produce a substantially homogenous mixture (wherein in the mixture the surface-active, isocyanate-reactive material is rendered water-dispersible by appropriate content of non-ionic and/or neutralized ionic hydrophilizing functionality);

(ib) adding the isocyanate crosslinking agent, either continuously or in portions, to the mixture from (ia) in the desired proportions and under conditions (e.g., stirring at ambient temperature) so that a water-in-oil emulsion is produced;

(iia) adding additional aqueous medium, either continuously or in portions, to the water-in-oil emulsions from (ib) in an amount and under conditions (e.g., stirring at ambient temperature) until phase inversion occurs; then

(iib) adding additional aqueous medium, either continuously or in portions, to the oil-in-water emulsions from (iia) in amounts and under conditions (e.g., stirring at ambient temperature) to achieve the desired solids content and viscosity.

In the aforementioned procedure, the optional neutralizing agent may preferably be used to preneutralize the surface-active, isocyanate-reactive material, and/or may be present as a part of the aqueous medium to neutralize during the initial mixing step (ia). In either case, sufficient neutralizing agent should be present in an amount sufficient to render the surface-active, isocyanate-reactive material water-dispersible.

The aqueous medium may include solely water or may, as indicated above, include other components, such as the optional neutralizing agent. Other than the neutralizing agent, the aqueous medium may also include any one of a number of other additives common to the end use, as well as minor amounts (at most) of water-miscible organic solvents to facilitate emulsification or to adjust viscosity, although this use of added organics is not preferred. It is preferred that any such additional ingredients be incorporated along with the surface-active, isocyanate-reactive material and isocyanate crosslinking agent; in other words, it is preferred that the aqueous medium include solely water, or water and a neutralizing agent. Most preferably, the aqueous medium is solely water.

As indicated above, in step (i) the aqueous medium and surface-active isocyanate-reactive material are mixed, followed by the isocyanate crosslinking agent, in proportions and under conditions sufficient to achieve a water-in-oil emulsion. The amount of each component required to achieve a water-in-oil emulsion, of course, will vary depending on a number of factors recognizable by those of ordinary skill in the art. One important factor is the hydrophilicity/lipophilicity of the non-water components of the emulsion and the relationship that this has to the amount of water that can be present in the system before phase inversion occurs. It is, however, well within the abilities of the ordinary-skilled person to determine by routine methods the phase inversion point of a given formulated system and the amount of water that the system can tolerate prior to the onset of phase instability. Preferably, and typically, the water-in-oil emulsion will include up to about 50% by weight water, and more preferably from about 35% to about 45% by weight water.

From the determination of the phase inversion point of the formulated system, the ordinary-skilled person can then readily determine the amount of additional aqueous medium that needs to be added in step (ii) to achieve phase inversion. Further, based on a particular chosen end use, the ordinary-skilled person can readily adjust the solids/water content of the oil-in-water emulsions to those required for that end use.

Via the above procedure, substantially homogenous, curable, oil-in-water emulsions can be produced which may find use in a variety of fields including, for example, coatings and adhesives applications.

A primary use of the curable oil-in-water emulsions of the present invention is in the coatings industry, for example, in automotive original equipment manufacturing (OEM), industrial maintenance, electrodeposition and, particularly, ambient temperature cure automotive refinish applications. The coatings are also useful, for example, in architectural, coil, can, plastic, and wood coating applications. The curable emulsions may be used in clearcoat applications, or may contain a pigment for other applications.

For coatings applications, typical solids contents generally range from about 20% to about 75% by weight solids, but preferably are in the range of from about 30% to about 55% by weight solids, depending on the method of application chosen. For the purpose of the present invention, solids content is determined in accordance with ASTM D4713 (method B).

An especially preferred application for these curable emulsions is as an ambient temperature cure, automotive refinish clearcoat.

Coatings obtained from these curable emulsions may be applied to a variety of substrates in any desirable manner, such as by roller coating, spraying, brushing, sprinkling, flow coating, dipping, electrostatic spraying and electrophoresis. A preferred method of application is by spraying, and one of ordinary skill in the art can formulate the aqueous coating compositions so as to be sprayable (e.g., with an appropriate spray viscosity) as indicated above.

Depending on the ultimate end use, coatings may be formulated as ambient or elevated temperature cure systems. For example, for refinish coatings applications the coatings will be formulated for ambient cure (although they may in fact be cured at elevated temperatures), whereas for automotive original equipment manufacturing (OEM) applications the coatings will be formulated for cure at elevated temperatures of, typically, 125° C.

All molecular weights referred to herein shall be understood to be in grams per mole, unless otherwise noted.

The phrase “substantially free of,” as used herein in reference to an item, should be understood to mean having less than about 5% by volume, preferably less than about 2% by volume, more preferably less than about 1% by volume, most preferably completely free, of the item.

The term “about,” as used herein with respect to a range of values, should be understood to modify either value stated in the range, or both.

### EXAMPLES

### Examples 1-18: Comparative Examples of Low-VOC Surface-Active Isocyanate-Reactive Material Containing Acrylic Acid Monomers

Example 1: In Situ Preparation of Low-VOC Surface-Active Isocyanate-Reactive Material Containing 4-HBA and Styrene Monomers with Acrylic Acid

2-Heptanone (MAK Solvent), 98% (427.5 g) was added to a 3-liter jacketed reactor equipped with a stirrer, a reflux condenser, and a thermocouple under a blanket of nitrogen and heated with oil to 148-150° C. A monomer feed mixture (2300 grams total) of butyl acrylate (40.80 wt %), 4-hydroxybutyl acrylate (27.90 wt %), methyl methacrylate (14.90 wt %), styrene (9.99 wt %) and acrylic acid (6.41 wt %) was prepared and charged to a graduated cylinder attached to a feed pump. Di-tertiary amyl peroxide (d-t-APO) (165.6 grams total) was charged to a feed pump. Catalyst feed (7.5 g) was added over thirteen minutes before the addition of monomer. Using a piston-metering pump, the monomer was added to the reactor over four hours and thirty-five minutes. During this time the reaction temperature reached a maximum of 150° C. The total reaction time was six hours and five minutes. After the addition of all the monomer feed, 26.6 g of catalyst was fed over an additional fifty-six minutes. The reactor was heated and stirred at 146-151° C. for an additional twenty-one minutes.

The polymer solution was cooled and analyzed. The concentration was determined to be 82.5 weight percent. The relative number average molecular weight of the polymer solution was 5580; a polydispersity index of 18.8 was obtained via high-pressure size exclusion chromatography compared against polystyrene standards. The glass transition temperature of a dried film was determined to be 2° C. via differential scanning calorimetry. The acidity was calculated to be 41 mg of KOH per gram of solution; the hydroxy concentration was calculated to be 2.55 weight percent; and the viscosity was determined to be greater than 98,000 centipoise at 25° C.

### Example 2: Production of Low-VOC Surface-Active Isocyanate-Reactive Material Containing 4-HBA and Styrene Monomers with Acrylic Acid Having Increased Solvent Removal

In one attempt to decrease the molecular weight and viscosity by decreasing any esterfication reactions, the material of Example 2 was prepared as in Example 1 but at a lower concentration with additional solvent removed by vacuum stripping. When performed, the undesirable esterification reactions were reduced because of the lower solids reached during polymerization and the low temperatures used to remove the solvent.

2-Heptanone (MAK Solvent), 98% (576.5 g) was added to a 3-liter jacketed reactor equipped with a stirrer, a reflux condenser, and a thermocouple under a blanket of nitrogen and heated with oil to 139-151° C. A monomer feed mixture (2285 grams total) consisting of butyl acrylate (40.84 wt %), 4-hydroxybutyl acrylate (27.97 wt %), methyl methacrylate (14.74 wt %), styrene (10.02 wt %) and acrylic acid (6.43 wt %) was prepared and charged to a graduated cylinder attached to a feed pump. Di-tertiary amyl peroxide (d-t-APO) (185.1 grams total) was charged to a feed pump. Catalyst feed (6.6 g) was added over ten minutes before the addition of monomer. Using a piston-metering pump, the monomer was added to the reactor over five hours and thirty-two minutes. During this time the reaction temperature reached a maximum of 150° C. The total reaction time was six hours and twelve minutes. After the addition of all the monomer feed, 8.6 g of catalyst was fed over an additional eighteen minutes. The reactor was heated and stirred at 134-135° C. for an additional twelve minutes. The polymer solution was cooled and analyzed. The concentration was determined to be 76.2 weight percent. The relative number average molecularweight of the polymer solution was 2930. A polydispersity index of 4.8 was obtained via high-pressure size exclusion chromatography compared against polystyrene standards. The material was removed from the reactor and solvent removed via a Buchi roto-evaporator at 80-100° C. under vacuum. The polymer solution after solvent removal was cooled and analyzed. The concentration was determined to be 87.6 weight percent. The relative number average molecular weight of the polymer solution was 3070. A polydispersity index of 5.3 was obtained via high-pressure size exclusion chromatography compared against polystyrene standards. This example shows that the molecular weight does not increase dramatically with increased solvent removal under vacuum.

### Example 3: Atmospheric Solvent Removal of Low-VOC Surface-Active Isocyanate-Reactive Material Containing 4-HBA and Styrene Monomers

The procedure of Example 2 was followed with removal of the solvent at atmospheric pressure. At atmospheric pressure, the high temperatures needed to remove the solvent facilitate esterification reactions, which can lead to gelation.

2-Heptanone (MAK Solvent), 98% (573.6 g) was added to a 3-liter jacketed reactor equipped with a stirrer, a reflux condenser, and a thermocouple under a blanket of nitrogen and heated with oil to 139-151° C. A monomer feed mixture (2285 grams total) consisting of butyl acrylate (40.85 wt %), 4-hydroxybutyl acrylate (27.98 wt %), methyl methacrylate (14.74 wt %), styrene (10.00 wt %) and acrylic acid (6.43 wt %) was prepared and charged to a graduated cylinder attached to a feed pump. Di-tertiary amyl peroxide (d-t-APO) (185.0 grams total) was charged to a feed pump. Catalyst feed (6.6 g) was added over ten minutes before the addition of monomer. Using a piston-metering pump, the monomer was added to the reactor over five hours and twenty minutes. During this time the reaction temperature reached a maximum of 150° C. After the addition of all the monomer feed, 8.2 g of catalyst was fed over an additional fifteen minutes. The reactor was heated and stirred at 134-135° C. for an additional twelve minutes. At five hours and 45 minutes a sample was taken for molecular weight, and the concentration was calculated. The concentration was determined to be approximately 75 weight percent. The relative number average molecular weight of the polymer solution was 3310. A polydispersity index of 4.5 was obtained via high-pressure size exclusion chromatography compared against polystyrene standards. The solvent was stripped from the solution at 145-153° C. and nearly atmospheric conditions using a Dean-Stark tube mounted on the reactor.

A sample was taken after seven hours and twenty minutes, and the concentration was calculated. The concentration was determined to be approximately 81 weight percent. The relative number average molecular weight of the polymer solution was 3320. A polydispersity index of 13.9 was obtained via high-pressure size exclusion chromatography compared against polystyrene standards. A sample was taken at 8 hours and 4 minutes, and the concentration was calculated to be approximately 83 weight percent. The relative number average molecular weight of the polymer solution was 3540. A polydispersity index of 44.4 was obtained via high-pressure size exclusion chromatography compared against polystyrene standards. At 8 hours and 10 minutes the polymer solution was essentially gelled in the reactor. Example 3 illustrates the significant increase in the molecular weight and gelling of the polymer under atmospheric solvent removal conditions.

TABLE 1
Advances in Molecular Weight Over Time

| | Reaction End | 68% Solv. Rmvd. | 85% Solv. Rmvd. |
|---|---|---|---|
| Mol. Wt. | 5 hrs. 45 mins. | 7 hrs. 20 mins. | 8 hrs. 4 mins. |
| % VOC | ˜25 | ˜19 | ˜17 |
| Mₙ | 3,310 | 3,320 | 3,540 |
| M_{w} | 14,800 | 46,200 | 157,000 |
| PDI | 4.5 | 13.9 | 44.4 |
| % > 100K | 0.8 | 9.9 | 19.2 |
| 50-100K | 5.3 | 5.7 | 9 |
| 20-50K | 15.4 | 16 | 10.9 |
| 10-20K | 13.6 | 16 | 9.1 |
| 5-10K | 22 | 12.3 | 15.7 |
| 1-5K | 35.4 | 31.4 | 28.9 |
| % < 1K | 7.6 | 8.7 | 7.3 |

PDI represents a polymer's polydispersity index, which is the ratio of M_{w} to Mₙ.

Note that, as the time increased during solvent stripping at 150° C., the polydispersity dramatically increased from 4.5 to 44.4. The main source of the molecular weight increase was from the 1 K to 10 K molecular weight species. Molecular weights as high as 3 million were calculated based on polystyrene standards.

### Example 4: Production of Low-VOC Surface-Active Isocyanate-Reactive Material Containing 4-HBA with Acrylic Acid

2-Heptanone (MAK Solvent), 98% (65 g) was added to a 500 milliliter reactor equipped with a stirrer, a refiux condenser, and a thermocouple under a blanket of nitrogen and heated with an oil bath to 148-151° C. A monomer feed mixture (372 grams total) consisting of butyl acrylate (40.86 wt %), 4-hydroxybutyl acrylate (27.81 wt %), methyl methacrylate (24.88 wt %), acrylic acid (6.41 wt %) was prepared. The monomer feed was charged to a graduated cylinder attached to a feed pump. Di-tertiary amyl peroxide (d-t-APO) (27.88 grams total) was charged to a feed pump. Catalyst feed (1.6 g) was added over ten minutes before the addition of monomer. Using a piston-metering pump, the monomer was added to the reactor over four hours and forty-four minutes. During this time the reaction temperature reached a maximum of 151° C. The total reaction time was five hours and eight minutes. After the addition of all the monomer feed, 1.2 g of catalyst was fed over an additional twenty minutes. A sample was taken for molecular weight analysis when the reaction was completed at five hours and eight minutes and the reactor was removed from the oil bath and allowed to cool to room temperature overnight It was reheated the next morning to 150° C. After one hour of heating a sample was taken for molecular weight analysis. The entire reactor contents were noticed gelled after one and one-half hours at 150° C.

TABLE 2
Stability On Heating

| Molecular Weight Analysis | End Of Addition | Overnight + Reheat |
|---|---|---|
| Mₙ | 2,650 | 2,690 |
| M_{w} | 30,800 | 47,900 |
| PDI | 11.6 | 17.8 |
| % > 100K | 8.2 | 13 |
| 50-100K | 8.4 | 8.6 |
| 20-50K | 13.4 | 12.8 |
| 10-20K | 12.4 | 11.6 |
| 5-10K | 14.5 | 13.5 |
| 1-5K | 33.4 | 31.6 |
| % <1K | 10 | 9 |

### Examples 5-6: Production of Low-VOC Surface-Active Isocyanate-Reactive Material Without Both Esterification Components

Using the method of Example 4, two materials were synthesized having only one of the two components necessary for esterification; one with no COOH (Example 5) and one with no OH (Example 6). Post heating experiments were performed and samples taken for analysis of molecular weight, as shown in Tables 3 and 4.

TABLE 3
Example 5 (with 4-HBA, without Acrylic Acid)

| | Reaction | Start | 1 Hr. | 2 Hrs. | 4 Hrs. | 7 Hrs. |
|---|---|---|---|---|---|---|
| Mol. Wt. | End | Reheat | Later | Later | Later | Later |
| Mₙ | 2054 | 2230 | 1818 | 1759 | 1832 | 1914 |
| M_{w} | 4832 | 5381 | 4842 | 4823 | 4918 | 5151 |
| PDI | 2.4 | 2.4 | 2.7 | 2.7 | 2.7 | 2.7 |
| % > 100K | 0 | 0 | 0 | 0 | 0 | 0 |
| 50-100K | 0 | 0 | 0 | 0 | 0 | 0.1 |
| 20-50K | 1.9 | 3 | 2 | 2.1 | 2.3 | 2.6 |
| 10-20K | 9.6 | 10.7 | 9.8 | 9.7 | 9.9 | 10.2 |
| 5-10K | 21.4 | 22.2 | 21.1 | 20.8 | 21.1 | 21.2 |
| 1-5K | 55.9 | 54.1 | 53.6 | 53.6 | 53.9 | 53.7 |
| % < 1K | 11.4 | 9.5 | 13 | 13.9 | 12.9 | 12.3 |

TABLE 4
Example 6 (without 4-HBA, with Acrylic Acid)

| Mol. | Reaction | Start | 1 Hr. | 2 Hrs. | 3 Hrs. | 5 Hrs. | 7 Hrs. |
|---|---|---|---|---|---|---|---|
| Wt. | End | Reheat | Later | Later | Later | Later | Later |
| Mₙ | 1587 | 1721 | 1651 | 1616 | 1587 | 1670 | 1635 |
| M_{w} | 3741 | 3751 | 3762 | 3747 | 3771 | 3763 | 3808 |
| PDI | 2.4 | 2.2 | 2.3 | 2.3 | 2.4 | 2.3 | 2.3 |
| % > 100K | 0 | 0 | 0 | 0 | 0 | 0 | 0 |
| 50-100K | 0 | 0 | 0 | 0 | 0 | 0 | 0 |
| 20-50K | 0.4 | 0.3 | 0.4 | 0.4 | 0.5 | 0.3 | 0.5 |
| 10-20K | 5.2 | 5.1 | 5.2 | 5.2 | 5.3 | 5.2 | 5.5 |
| 5-10K | 18.8 | 19.3 | 19.1 | 19.1 | 18.9 | 19.2 | 19.2 |
| 1-5K | 60.3 | 61.5 | 60.1 | 60.3 | 59.4 | 60.1 | 59.9 |
| % < 1K | 15.4 | 14 | 14.9 | 15.2 | 15.5 | 14.7 | 15.1 |

Gelling did not occur with these materials after additional heating for seven hours. Only slight changes in MW distribution were observed over this time frame.

### Example 7: Production of Low-VOC Surface-Active Isocyanate-Reactive Material Containing 4-HBA with Acrylic Acid in Non-MAK Solvent

Again, following the method of Example 4, the material of Example 7 was prepared with propylene glycol monoethyl ether acetate (PM-OAc) as the solvent, instead of 2-heptanone (MAK), to probe the possibility of solvent-related effects on esterification. Unfortunately, the material gelled after reheating to 144° C. The material was reheated for a total time of only 79 minutes with gelation occurring 29 minutes after reaching 130 degrees. Little difference is noted in the HPSEC results but the material had gelled so much that the some of the material was no longer soluble in the THF eluent.

TABLE 5
Stability on Heating

| Mol. Wt. | Reaction End | Start Reheat | ½ Hour Later |
|---|---|---|---|
| Mₙ | 3580 | 3860 | 3520 |
| M_{w} | 118800 | 183900 | 195100 |
| PDI | 33.2 | 47.6 | 55.4 |
| % > 100K | 19.9 | 22.8 | 21 |
| 50-100K | 7.7 | 7.3 | 6.8 |
| 20-50K | 11.8 | 11.4 | 11.1 |
| 10-20K | 11.2 | 10.9 | 10.8 |
| 5-10K | 13.7 | 13.2 | 13.3 |
| 1-5K | 29.5 | 28.5 | 29.6 |
| % < 1K | 6.4 | 6 | 6.9 |

### Examples 8-15: Viscosity of Low-VOC Surface-Active Isocyanate-Reactive Material Versus Time In Isothermal Experiments

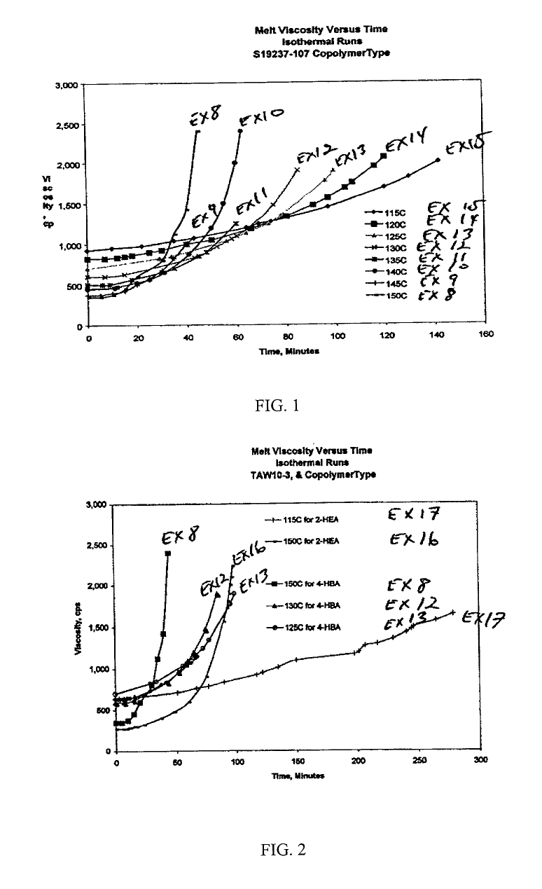

A series of experiments were performed using the material produced in Example 2. Using a melt viscometer (Brookfield Programmable DV-II+Viscometer with Thermosel Control, spindle number 27 at 20 rpm), the viscosity over time was monitored at various temperatures. Melt viscosities were monitored at 150° C. (the polymerization temperature) for anywhere from about 45 minutes (Example 8) to about 140 minutes (Example 15) and the temperature decreased stepwise 5° C. for each successive Example, down to a low of 115° C. The results are shown graphically in FIG. 1. Notice that the stability is improved as the temperature is lowered from 150° C. down to 115° C., but the material was not completely stable at any temperature tested.

### Examples 16-18: Comparison of 2-Hydroxyethyl Acrylate to 4-Hydroxybutyl Acrylate Monomer in Low-VOC Surface-Active Isocyanate-Reactive Material

The viscosity of a low-VOC styrenic surface-active isocyanate-reactive material, containing 2-hydroxyethyl acrylate (HEA) and acrylic acid, was examined at 150° C. in Example 16 and at 115° C. in Example 17. Example 18 contained 4-HBA instead of HEA, similar to the material of Example 8. The viscosity of sample 18 was monitored for a longer time than in Example 8.

For producing the material of examples 16-17, 2-Heptanone (MAK Solvent), 98% (71.7 g) was added to a 500 milliliter reactor equipped with a stirrer, a reflux condenser, and a thermocouple under a blanket of nitrogen and heated with an oil bath to 148-151° C. A monomer feed mixture (395.8 grams total) consisting of styrene (10.00 wt %), butyl acrylate (50.00 wt %), 2-hydroxyethyl acrylate (21.96 wt %), methyl methacrylate (11.63 wt %), acrylic acid (6.41 wt %) was prepared. The monomer feed was charged to a graduated cylinder attached to a feed pump. Di-tertiary amyl peroxide (d-t-APO) (15.56 grams total) was charged to a feed pump. Catalyst feed (1.2 g) was added over thirteen minutes before the addition of monomer. Using a piston-metering pump, the monomer was added to the reactor over five hours and two minutes. During this time the reaction temperature reached a maximum of 151° C. The total reaction time was six hours and two minutes. After the addition of all the monomer feed, 0.8 g of catalyst was fed over an additional seventeen minutes. The reactor was heated and stirred at 146-150° C. for an additional thirty minutes.

The polymer solution was cooled and analyzed. The concentration was determined to be 84.1 weight percent. The relative number average molecular weight of the polymer solution was 4400; a polydispersity index of 6.7 was obtained via high-pressure size exclusion chromatography compared against polystyrene standards. The glass transition temperature of a dried film was determined to be 0.3° C. via differential scanning calorimetry. The acidity was calculated to be 42 mg of KOH per gram of solution; the hydroxy concentration was calculated to be 2.59 weight percent.

Although the HEA-containing material is more stable than HBA at the polymerization temperature of 150° C., it also showed an increase in viscosity over time and thus also underwent esterification. A comparison of the viscosity profile at 150° C. of the HEA-containing polymer (Example 16) with the viscosity profiles of the HBA-containing polymer (Examples 8, 12 and 13) demonstrated that there was an acceptable viscosity increase when the polymerization temperature of HBA-containing polymers was 130° C. or less. There was also an acceptable viscosity increase when the polymerization temperature of the HEA-containing polymers was less than 150° C., as shown in FIG. 2.

### Examples 19-21: Preparation of Low-VOC Surface-Active Isocyanate-Reactive Material According to the Invention Containing Methacrylic Acid Monomers

Examples 19-21 represent the polymers of the present invention, in which the acrylic acid of Comparative Examples 1-18 was substituted with methacrylic acid to prepare a HBA styrenic type carboxylated polyol resin. Both the calculated acid content and glass transition temperature of the polymers of Examples 19-21 were adjusted to yield values similar to those measured for the polymers of Example 1.

2-Heptanone (MAK Solvent), 98% (50 g) was added to a 500 ml reactor equipped with a stirrer, a reflux condenser, and a thermocouple under a blanket of nitrogen and heated with oil to 148-150° C. A monomer feed mixture (282 grams total) consisting of butyl acrylate (44.32 wt %), 4-hydroxybutyl acrylate (27.95 wt %), methyl methacrylate (9.99 wt %), styrene (10.07 wt %) and methacrylic acid (7.67 wt %) was prepared and charged to a graduated cylinder attached to a feed pump. Di-tertiary amyl peroxide (d-t-APO) (36.9 grams total) was charged to a feed pump. Catalyst feed (4.1 g) was added over ten minutes before the addition of monomer. Using a piston-metering pump, the monomer was added to the reactor over four hours and twenty minutes. During this time the reaction temperature reached a maximum of 151° C. The total reaction time was six hours and ten minutes. After the addition of all the monomer feed, 26.6 g of catalyst was fed over an additional twenty minutes. The reactor was heated and stirred at 146-151° C. for an additional twenty minutes. A sample was taken (Example 19) for molecular weight analysis and melt viscosity profile at five hours and seven minutes. The polymer solution was cooled and analyzed. The concentration was determined to be 84.5 weight percent. The relative number average molecular weight of the polymer solution was 3125; a polydispersity index of 4.0 was obtained via high-pressure size exclusion chromatography compared against polystyrene standards. The glass transition temperature of a dried film was determined to be 2° C. via differential scanning calorimetry. The acidity was calculated to be 42 mg of KOH per gram of solution; the hydroxy concentration was calculated to be 2.62 weight percent, the viscosity was determined to be 37,944 centipoise at 25° C.

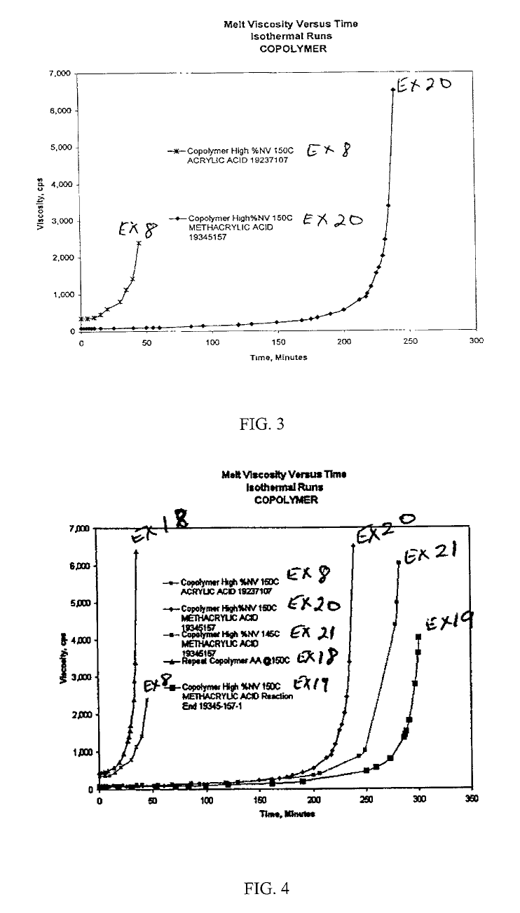

The viscosity profile was determined at 150° C. in Example 20 and also at 145° C. in Example 21. The stability was determined using a melt viscometer at the end of the reaction sample (Example 19) and after an additional heating time of one hour (Examples 20-21), which were compared to the acrylic acid-containing polymer of Example 8. The results were unexpected in that the methacrylic acid copolymer stability was increased five fold over the acrylic acid copolymer. The viscosities of Examples 19-21 are shown in FIGS. 3 and 4.

Note that, from FIG. 2, at 45 minutes the viscosity of the acrylic acid-containing polymer (Example 8) was 2400 cps. This viscosity would have been reached in the methacrylic acid-containing polymer (Example 20) at about 232 minutes. In addition, two samples were taken for HPSEC analysis to monitor the molecular weight advancement in the reactor, as shown in Table 6.

TABLE 6
Stability On Heating

| | Reaction End | 1 Hour Later |
|---|---|---|
| Mol. Wt. | Example 19 | Example 20 |
| Mₙ | 2885 | 3125 |
| M_{w} | 8876 | 12641 |
| PDI | 3.1 | 4 |
| % > 100K | 0 | 0.6 |
| 50-100K | 1.5 | 4.4 |
| 20-50K | 9.9 | 13.8 |
| 10-20K | 15.3 | 15.8 |
| 5-10K | 21.1 | 19.4 |
| 1-5K | 45.8 | 40.3 |
| % < 1K | 6.1 | 6 |

Luperox ® DTA Initiator ˜ 150° C. Pan Solids = 84.5%

The molecular weight increase after one hour at 150° C. was slight. Viscosity measurements for these materials are shown in FIG. 4. Also shown are the acrylic acid-containing polymer at 150° C. (the “control”—Comparative Example 18) and the methacrylic acid-containing polymer product at 145° C. (Example 21).

### Example 22: Preparation of Low-VOC Surface-Active Isocyanate-Reactive Material According to the Invention Containing Methacrylic Acid Monomers

To see if the dramatic effect observed in Examples 19-21 was realized with other hydroxy-acrylates, Example 22 contains a hydroxy ethyl acrylate with methacrylic acid and styrenic monomers. In this example, a low-VOC styrenic surface-active isocyanate-reactive material was prepared by a method similar to that used in Examples 16-17, with the substitution of methacrylic acid for acrylic acid.

2-Heptanone (MAK Solvent), 98% (420 g) was added to a 3-liter jacketed reactor equipped with a stirrer, a reflux condenser, and a thermocouple under a blanket of nitrogen and heated with oil to 146-155° C. A monomer feed mixture (2328 grams total) consisting of butyl acrylate (52.35 wt %), 2-hydroxyethyl acrylate (21.97 wt %), methyl methacrylate (8.00 wt %), styrene (10.00 wt %) and methacrylic acid (7.68 wt %) was prepared and charged to a graduated cylinder attached to a feed pump. Di-tertiary amyl peroxide (d-t-APO) (156.7 grams total) was charged to a feed pump. Catalyst feed (6.6 g) was added over ten minutes before the addition of monomer. Using a piston-metering pump, the monomer was added to the reactor over four hours and fifty-six minutes. During this time the reaction temperature reached a maximum of 155° C. The total reaction time was five hours and fifty-five minutes. After the addition of all the monomer feed, 8.2 g of catalyst was fed over an additional seventeen minutes. The reactor was heated and stirred at 151-152° C. for an additional thirty-six minutes. The polymer solution was cooled and analyzed. The concentration was determined to be 85.2 weight percent. The relative number average molecular weight of the polymer solution was 2965; a polydispersity index of 3.0 was obtained via high-pressure size exclusion chromatography compared against polystyrene standards. The viscosity profile was determined at 150° C.

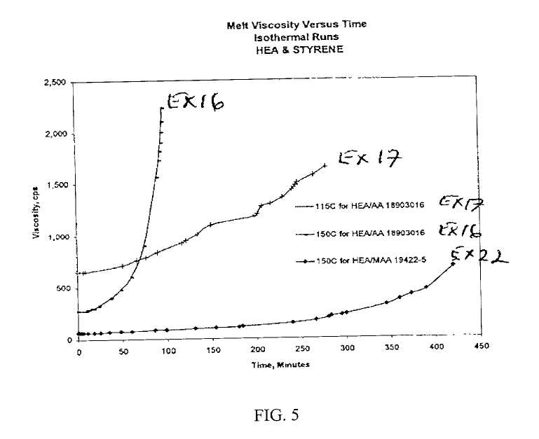

We compared the viscosity profile at 150° C. of Example 22 to the HEA-containing acrylic acid polymer of Example 16 (also at 150° C.) and the HEA-containing acrylic acid polymer of Example 17 (at 115° C.). Example 22 is significantly more stable than the acrylic acid-containing polymers, as shown in FIG. 5.

Although the present invention is described with reference to certain preferred embodiments, it is apparent that variations or modifications thereof may be made by those skilled in the art without departing from the scope of this invention as defined by the appended claims.

What is claimed is:

1. A polymeric, macromonomeric, or oligomeric high-temperature-gelation-resistant material that includes both sterically hindered carboxylic acid groups and carboxylic acid-reactive groups, such that the material has an improved pot-life and exhibits a viscosity below about 1000 cps for at least about 60 minutes at a temperature in the range of about 115° C. to 180° C.

2. The high-temperature-gelation-resistant material of claim 1, wherein the acid-reactive groups are hydroxyl groups and the carboxylic acid groups are provided by methacrylic acid monomers, and wherein the material is formed by free-radical polymerization of methacrylic acid monomers with at least one hydroxy-functional comonomer and, optionally, at least one other acrylate or methacrylate comonomer.

3. The high-temperature-gelation-resistant material of claim 1, wherein the material exhibits a viscosity below about 500 cps for at least about 120 minutes at about 150° C.

4. The high-temperature-gelation-resistant material of claim 1, wherein the material exhibits a viscosity below about 300 cps for at least about 180 minutes at about 150° C.

5. The high-temperature-gelation-resistant material of claim 1, wherein the material exhibits an Mₙ between about 1,000 and 50,000 for at least about 60 minutes at a temperature in the range of about 115° C. to 180° C.

6. A process for improving the pot life of a high-temperature-gelation-resistant material that comprises copolymerizing sterically hindered carboxylic acid-containing monomers with at least one hydroxy-functional comonomer and, optionally, at least one other acrylate or methacrylate comonomer, at a sufficient polymerization temperature and for a sufficient time to create a copolymer with a viscosity below about 1000 cps or an Mₙ of about 1,000 to 50,000, wherein the viscosity of the material remains below about 1000 cps or the Mₙ remains between about 1,000 and 50,000 for at least about 60 minutes at a temperature in the range of about 115° C. to 180° C.

7. A process for preparing an isocyanate-based, curable oil-in-water emulsion, comprising the steps of:
(i) admixing (a) an unblocked isocyanate crosslinking agent containing at least two reactive isocyanate groups, the agent being substantially hydrophobic and non-dispersible in water, with (b) a mixture of the high-temperature-gelation-resistant material of claim 1, and an aqueous medium, wherein, in the mixture, the high-temperature-gelation-resistant material is water-dispersible; in proportions and under conditions sufficient to produce a substantially homogenous curable water-in-oil emulsion having a VOC content of about 2.1 lbs/gal (252 g/l) or less; then
(ii) admixing the curable water-in-oil emulsion from step (i) with an aqueous medium in proportions and under conditions sufficient to produce a substantially homogenous oil-in-water emulsion of the high-temperature-gelation-resistant material and the isocyanate crosslinking agent in water, the oil-in-water emulsion having a VOC content of about 2.1 lbs/gal (252 g/l) or less.

8. The process of claim 7, wherein the admixing of step (i) comprises:
adding the aqueous medium to the high-temperature-gelation-resistant material to produce a substantially homogenous mixture;
adding the isocyanate crosslinking agent to the substantially homogenous mixture to produce the water-in-oil emulsion;
adding an aqueous medium to the water-in-oil emulsion until a phase inversion occurs, thereby forming the oil-in-water emulsion; and
adding additional aqueous medium to the oil-in-water emulsion such that the oil-in-water emulsion has a desired solids content and viscosity.

9. The process of claim 7, wherein the high-temperature-gelation-resistant material is a copolymer comprising styrene and a hydroxyalkyl acrylate or methacrylate.

10. The process of claim 9, wherein the hydroxyalkyl acrylate or methacrylate comprises 4-hydroxybutyl methacrylate or 4-hydroxybutyl acrylate.

11. The process of claim 9, which further comprises at least one additional comonomer.

12. The process of claim 11, wherein the at least one additional comonomer is selected from the group consisting of methyl methacrylate, butyl acrylate, methacrylic acid, and a mixture thereof.

13. The process of claim 7, wherein the high-temperature-gelation-resistant material is from about 30% to about 60% neutralized.

14. The process of claim 8, which further comprises adding a neutralizing agent to the aqueous medium.

15. The process of claim 7, wherein the aqueous medium comprises water added in an amount such that the water-in-oil emulsion comprises up to about 40% by weight water.

16. The process of claim 7, wherein the unblocked isocyanate crosslinking agent is selected to comprise a tertiary polyisocyanate.

17. A curable water-in-oil emulsion comprising a substantially homogeneous emulsion of water in a mixture of the high-temperature-gelation-resistant material of claim 1, which has been at least partially neutralized, has a hydroxyl content of at least 1.5 wt % (based on 48 wt % solids), has a T_{g} of less than about 0° C., and is dispersible in water, with an unblocked isocyanate crosslinking agent, which contains at least two reactive isocyanate groups and which is substantially hydrophobic and non-dispersible in water, the curable water-in-oil emulsion having a VOC content of about 2.1 lbs/gal (252 g/l) or less.

18. A coated substrate comprising the high-temperature-gelation-resistant material of claim 1 or a reaction product thereof.

19. The coated substrate of claim 18, wherein the high-temperature-gelation-resistant material or a reaction product thereof is present in a coating formed on the article.

20. A coated substrate comprising a high-temperature-gelation-resistant material, having an improved pot life and formed according to the process of claim 6, or a reaction product thereof.

21. The coated substrate of claim 20, wherein the high-temperature-gelation-resistant material or a reaction product thereof is present in a coating formed on the article.

22. An article comprising an isocyanate-based, curable oil-in-water emulsion formed according to the process of claim 7.

23. The article of claim 22, wherein the high-temperature-gelation-resistant material or a reaction product thereof is present in a coating formed on the article.

24. An article comprising an isocyanate-based, curable water-in-oil emulsion formed according to the process of claim 17.

25. The article of claim 24, wherein the high-temperature-gelation-resistant material or a reaction product thereof is present in a coating formed on the article.

26. A process for providing a coating on an article comprising:
applying an isocyanate-based, curable oil-in-water emulsion formed according to the process of claim 7 on an article; and
drying the emulsion to form a coating.

27. A process for providing a coating on an article comprising:
applying an isocyanate-based, curable oil-in-water emulsion formed according to the process of claim 17 on an article; and
drying the emulsion to form a coating.
